(19) United States
(12) Patent Application Publication
(10) Pub. No.: US 2007/0243330 A1
(43) Pub. Date: Oct. 18, 2007

(54) MANUFACTURING METHOD OF LIQUID DISCHARGE HEAD

(75) Inventors: Hirokazu Komuro, Yokohama-shi (JP); Makoto Kurotobi, Yokohama-shi (JP); Tadashi Atoji, Yokohama-shi (JP); Takehito Okabe, Atsugi-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, TOKYO (JP)

(21) Appl. No.: 11/693,122

(22) Filed: Mar. 29, 2007

(30) Foreign Application Priority Data
Apr. 13, 2006 (JP) 2006-110941

(51) Int. Cl. B05D 3/00; B05D 3/12

(52) U.S. Cl. 427/299; 427/289

(57) ABSTRACT

Disclosed is a manufacturing method of a liquid discharge head having a discharge port which discharges a liquid, a flow path which communicates with the discharge port, a heating portion which is disposed correspondingly to the flow path and which generates heat energy for use in discharging the liquid from the discharge port and a protective layer which prevents the heating portion from being brought into contact with the liquid, the method comprising: forming porous silicon from a surface to an inner portion of a silicon substrate; sealing pores present in the surface of the porous silicon to smoothen the surface of the porous silicon; forming the protective layer on the smoothened surface of the porous silicon; forming the heating portion on the protective layer; forming the discharge port; and removing the porous silicon to form the flow path.

### BACKGROUND OF THE INVENTION

1. Field of the Invention

The present invention relates to a manufacturing method of a liquid discharge head which discharges a liquid.

2. Description of the Related Art

As an example in which a liquid discharge head is used, there is an ink jet recording system in which ink is discharged to a recording medium to record information.

In the ink jet recording system described in Japanese Patent Application Laid-Open No. S54-51837, heat energy is applied to a liquid to obtain a motive force for discharging the liquid. The recording method disclosed in the above document is different from another ink jet recording system in that the heat energy is applied to the liquid to obtain a motive force for discharging liquid droplets. Specifically, the liquid excessively heated by a function of the heat energy generates bubbles, and the liquid droplets are discharged from a discharge port by a force applied based on the generated bubbles. The liquid droplets are attached to the recording material to record the information.

A recording head applied to this recording method includes the discharge port generally disposed to discharge the liquid, a flow path which communicates with the discharge port, and a heating resistor as a heating portion which is a means for generating the heat energy in the flow path.

The head also includes a protective layer which prevents the heating portion from being brought into contact with the ink to protect the heating portion, and a lower layer which has a heat storage function for efficiently transmitting the heat energy. In a general method of forming the heating portion, the heat storage layer is formed on a substrate, the heating resistor and a wiring line are formed, patterning is performed by photolithography and an upper protective layer is formed on the patterned layer.

U.S. Pat. No. 6,533,399 discusses a manufacturing method of a so-called back shooter type ink jet recording head. In the method, the porous silicon is formed in a silicon substrate, the protective layer, a heating resistance layer and the heat storage layer are formed, and the porous silicon is then removed to form nozzles. Here, the back shooter type ink jet recording head is an ink jet recording head including the discharge port on a side opposite to a growing bubble via the heating portion.

However, when the ink jet recording head is prepared by the method disclosed in U.S. Pat. No. 6,533,399, it is considered that the following problem occurs.

The problem will specifically be described with reference to the drawings.

FIGS. 3A to 3C are schematic sectional views showing one example of a manufacturing method of the ink jet recording head according to a conventional technology.

As shown in FIG. 3A, a protective layer 203 of a heating portion is formed on porous silicon 202 disposed from the surface to an inner portion of a silicon substrate 201.

Next, as shown in FIG. 3B, heating portion 204 are formed on the protective layer 203.

Next, as shown in FIG. 3C, a discharge port 207 is formed. If necessary, wiring lines 205 and a heat storage layer 206 are formed. The resistor porous silicon 202 is removed to form a flow path 209. In consequence, the ink jet recording head is prepared.

However, when the protective layer 203 is formed as shown in FIG. 3A, a contact surface of the porous silicon 202 which comes into contact with the protective layer 203 has a concave and convex shape. Therefore, it is supposed that this shape is transferred onto the protective layer 203. This concave and convex shape remains on the surface of the protective layer 203 on a flow path 209 side of the completed head.

Therefore, when the liquid is discharged from the completed head, growing and disappearance of bubbles become unstable owing to the concave and convex shape of the surface of the protective layer. The disappearance of bubble means that bubbles grown to the maximum are constricted and disappear. As a result, it is difficult to obtain desired sizes of the discharged liquid droplets and a desired discharge direction. A recorded image is sometimes adversely affected.

Moreover, when the bubbles rapidly contract during the bubble disappearance, there is a problem in durability against collision (so-called cavitation) between the ink attracted toward the heating portions and a protective film.

### SUMMARY OF THE INVENTION

The present invention has been developed in view of the above respect, and an object of the present invention is to provide a liquid discharge head in which the surface of a heating resistance layer is smoothened, a bubbling state is set to be appropriate, and influences of a protective layer on bubbling are reduced. Another object is to provide a liquid discharge head in which durability of a protective film of a heating resistor is improved as compared with a conventional example.

The present invention is directed to a manufacturing method of a liquid discharge head having a discharge port which discharges a liquid, a flow path which communicates with the discharge port, a heating portion which is disposed so as to communicate with the flow path and which generates heat energy for use in discharging the liquid from the discharge port and a protective layer which prevents the heating portion from being brought into contact with the liquid. The method comprises: forming porous silicon from the surface to an inner portion of a silicon substrate; sealing pores present in the surface of the porous silicon which is the same surface as that of the silicon substrate to smoothen the surface of the porous silicon; forming the protective layer on the smoothened surface of the porous silicon; forming the heating portion on the protective layer; forming the discharge port; and removing the porous silicon to form the flow path.

In the present invention, the pores of the formed porous silicon are sealed, and the surface of the porous silicon is smoothened. In consequence, concave and convex portions of the protective layer formed on the surface of the porous silicon can be reduced to the utmost.

Therefore, a bubbling shape is appropriately formed, and the heat energy is smoothly converted into discharge energy. When a plurality of heating portions are arranged, bubbling fluctuations among the heating portions are generated by solid fluctuations of the concave and convex shape of the porous silicon, but the fluctuations can be suppressed in the present invention. The liquid discharge head capable of stably discharging the liquid can be provided. As a result, an image having a satisfactory recording quality level can be obtained. Moreover, in the liquid discharge head, durability of the protective film improves, and eroding of the heating portion by the ink can be prevented.

Further features of the present invention will become apparent from the following description of exemplary embodiments with reference to the attached drawings.

### BRIEF DESCRIPTION OF THE DRAWINGS

FIG. 1 is a schematic perspective view of an ink jet recording head according to an embodiment of the present invention;

FIGS. 2A, 2B, 2C, 2D, 2E, 2F, 2G and 2H are schematic sectional views showing one example of a manufacturing method of an ink jet recording head according to the embodiment of the present invention; and

FIGS. 3A, 3B and 3C are schematic sectional views showing one example of a manufacturing method of an ink jet recording head according to a conventional technology.

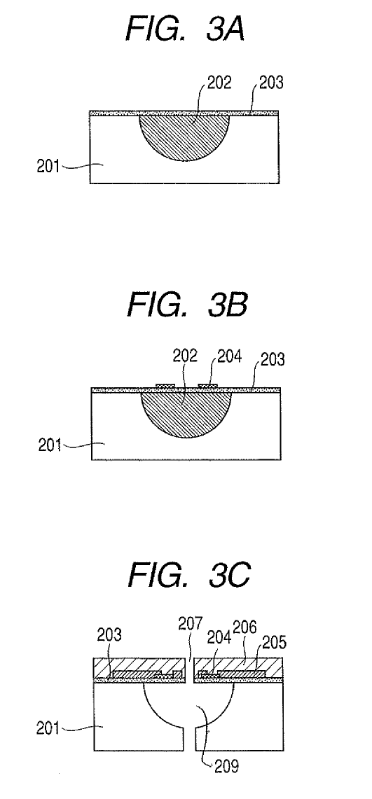

### DESCRIPTION OF THE EMBODIMENTS

The present invention will be described in accordance with an ink jet recording system as an application example of the present invention. However, an application range of the present invention is not limited to this example, and the present invention is applicable to not only preparation of a biochip and printing of an electronic circuit but also a liquid discharge head for a medical application such as discharging of a medicine.

First, an ink jet recording head to which the present invention is applicable will be described.

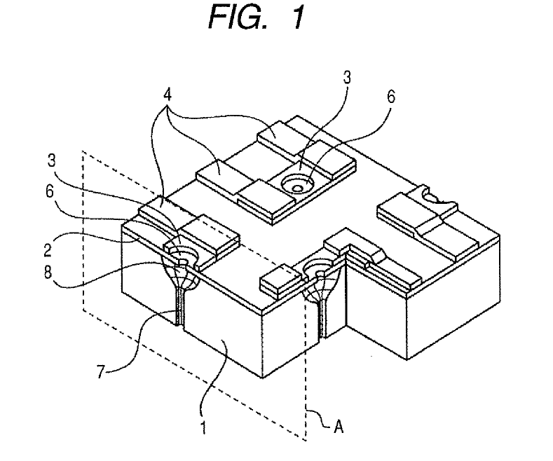

FIG. 1 is a partially cut schematic diagram of the ink jet recording head according to one embodiment of the present invention.

In the ink jet recording head of the present embodiment, a heating portion 3 as an energy generation element and a wiring line 4 are formed on a substrate 1 made of silicon via a protective layer 2 made of SiO₂. An electric signal is supplied to the heating portion via the wiring line 4. Furthermore, a discharge port 6 is formed which is an opening to discharge ink. The substrate 1 is also provided with a supply opening 7 which supplies ink, and the supply opening communicates with the discharge port 6 via a flow path 8. Here, the protective layer 2 is formed so as to prevent the ink flowing through the flow path 8 from being brought into contact with the heating portion 3, and prevents energization defects.

This ink jet recording head is disposed so that the surface provided with the discharge port 6 faces a recording surface of a recording medium. Moreover, in this ink jet recording head, the ink is boiled by heat generated by the heating portion 3, discharge energy is applied to discharge an ink droplet from the discharge port 6, and the droplet is attached to the recording medium to record information.

This ink jet recording head can be mounted on a device such as a printer, a photocopier, a facsimile machine and a word processor having a printer section, and a composite industrial recording device combined with various processing units.

Next, a manufacturing method of the ink jet recording head according to the present invention will be described in detail.

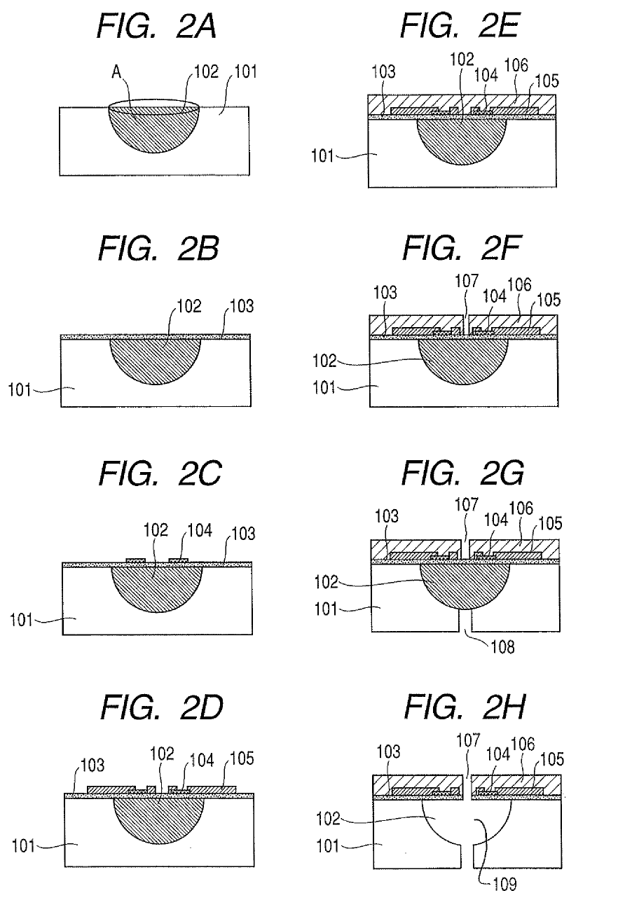

FIGS. 2A to 2H are schematic sectional views viewed along the surface A of FIG. 1.

First, as shown in FIG. 2A, porous silicon 102 is formed from the surface to an inner portion of a silicon substrate 101. A portion provided with the porous silicon is a region which is to form an ink flow path. The porous silicon 102 can be formed by anode formation performed in an HF solution by use of, for example, polyimide as a mask resist. According to the above method, the porous silicon can be formed with a thickness of 20 μm or more. A volume required for the ink flow path can sufficiently be secured. As another method, ions of a rare gas such as helium or argon, or hydrogen ions are implanted, and a thermal treatment is performed if necessary. In consequence, micro bubbles are generated in at least a part of silicon, and silicon can be constituted to be porous.

When porosity of the porous silicon is lowered, density of stacking defects of a layer formed on the porous silicon can be reduced. The porous silicon having low porosity can comparatively easily be realized by at least one method selected from a method of increasing an HF concentration, a method of decreasing a current density and a method of raising a temperature during the anode formation. The whole substrate may be constituted to be porous, or an only surface portion may be constituted to be porous. In the present invention, a step of further reducing the above density of the stacking defects of the upper layer and smoothening the surface of the porous silicon is performed by a sealing step described later.

Next, pores of the porous silicon are sealed (hereinafter referred to as the sealing step). The pores are present in the surface (including a case where the surface portion (A in the drawing) has a thickness) of the porous silicon having the surface which is continuous from the surface of the silicon substrate. This sealing step is performed in order to decrease the density of the pores in the surface of the porous silicon and reduce concave and convex portions of the surface.

The sealing step for use in the present invention is performed by thermally treating the porous silicon in a predetermined atmosphere. As the sealing method, at least one of the following (1) and (2) may be performed:

(1) pre-heating (pre-baking) in a reduction atmosphere which does not contain a silicon-based source gas but contains hydrogen; and

(2) a treatment (pre-injection) of thermally treating the porous silicon while supplying a micro amount of the silicon-based source gas, and applying silicon atoms to the porous silicon.

After the pre-baking, the pre-injection can be performed.

The porous silicon subjected to the sealing of the surface pores by the above method is thermally treated again (hereinafter referred to as intermediate baking) prior to epitaxial growth described later. The intermediate baking is performed at a temperature higher than that during the sealing. At this time, the supply of the silicon-based source gas is stopped in order to perform the intermediate baking in an atmosphere which does not contain any silicon-based gas. During the intermediate baking, the silicon-based source gas is unavoidably included as a contaminant in the intermediate baking atmosphere, but this has no problem.

Moreover, a non-porous single crystal layer is formed on the surface of the porous silicon subjected to the intermediate baking and having the sealed surface pores. A material constituting this non-porous single crystal layer may be silicon formed by homo-epitaxial growth or a material other than silicon formed by hetero epitaxial growth.

The above pre-baking will be described. During the pre-baking, a temperature can arbitrarily be selected from a range of 600° C. to 1150° C. In the present embodiment, the temperature can be set to a range of 850° C. to 1000° C., or an optimum range of 900° C. to 950° C. Even in such a low temperature range, a satisfactory result is obtained. Examples of the atmosphere for the pre-baking include a reduction atmosphere including 100% of hydrogen and a reduction atmosphere in which hydrogen is diluted with an inactive gas such as argon, but the pre-baking may be performed in a super-high vacuum. To produce a desired effect at low cost, the pre-baking can be performed in the hydrogen-containing reduction atmosphere. A usable pressure is in a range of 1×10⁻¹⁰ to 760 torrs.

As discussed in Japanese Patent Application Laid-Open No. H09-100197, during the pre-injection, a micro amount of the silicon atoms are supplied to the surface of the porous layer in an initial stage of the growth, and crystal defects are further effectively reduced.

A temperature and a pressure during the pre-injection may be selected from the above temperature and pressure ranges which are selectable during the pre-baking. An amount of the silicon-based source gas to be introduced can be set so that a deposition rate of silicon is about 20 nm/minute or less, more preferably 10 nm/minute or less, most preferably 2 nm/minute or less. In this case, crystal defects of the subsequently growing single crystal layer are further reduced.

Thus, the surface pores in the surface of the porous silicon are sealed. The silicon-based source gas is used in applying the silicon atoms to the surface of the porous layer to block the pores of the porous silicon. Examples of the gas include silicon H₂Cl₂, SiH₄, SiHCl₃, SiCl₄ and Si₂H₆. Silane which is a substrate at normal temperature and under normal pressure is more preferable in view of controllability of an amount of the gas to be supplied. When the pre-injection is performed by an MBE process instead of such a so-called CVD process, the silicon atom is supplied from a solid source. At this time, the substrate temperature can be set to be as low as 800° C. or less, and the growth rate can be set to 0.1 nm/minute or less.

All of the surface pores in the surface of the porous layer do not have to be sealed by the pre-injection. The sealing may be performed to such an extent that density of the remaining surface pores is about 1×10⁸ cm⁻² or less, more preferably 1×10⁶ cm⁻² or less.

Moreover, it can be confirmed whether or not a pre-injection time is sufficiently secured. This can be confirmed by measuring surface roughness of a semiconductor substrate subjected to the steps up to the pre-injection with an atomic force microscope (AFM).

The intermediate baking performed in the present invention is a heat treatment performed at a temperature higher than that of the sealing after the sealing of the pores. When the intermediate baking is performed, the surface roughness of the surface of the porous silicon having the sealed pores can further be decreased. There is also an effect that distortion in the vicinity of an interface between the porous silicon layer and the non-porous single crystal silicon layer is relaxed and the surface including the sealed pores is smoothened. Since this intermediate baking is performed, the density of the crystal defects of the non-porous single crystal layer formed on the porous layer does not increase. Most of the crystal defects of the non-porous single crystal layer formed on the porous layer are stacking defects. However, when the stacking defects are observed from the surface, the defect having an equal size is observed in a layer having an equal film thickness. That is, all of the stacking defects are generated in the vicinity of the interface between the porous silicon layer and the non-porous single crystal layer. The density of the stacking defects is determined by the pore sealing step. In the heat treatment of and after the sealing step, the stacking defect density hardly changes.

After this intermediate baking, at a desired heat treatment temperature, the non-porous single crystal silicon layer and a non-porous compound semiconductor single crystal layer epitaxially grow.

A temperature during the intermediate baking is selected from a range of 900° C. to 1150° C., more preferably 1000° C. to 1150° C. so that the temperature is higher than a temperature of the sealing step. The intermediate baking is performed in an atmosphere which does not substantially include the silicon-based source gas as described above. Examples of the atmosphere include the super-high vacuum, the reduction atmosphere including 100% of hydrogen and the reduction atmosphere in which hydrogen is diluted with an inactive gas such as argon. A pressure selection range is equal to that during the sealing step.

After the intermediate heat treatment is performed, the epitaxial growth is performed in which there is not any special restriction on the growth rate. Conditions may be the same as those for growth of well-known bulk state of silicon. Alternatively, the growth may continue at a growth rate equal to that of a step of supplying a micro amount of the raw material in the same manner as in the above pre-injection step. Even if gas species are changed, achievement of the object of the present invention is not hindered. When the same conditions as those of the step of supplying the micro amount of the raw material are selected, after the pre-injection, the supply of a material gas may once be discontinued to perform the intermediate baking. The supply of a desired raw material may be started again to perform the growth. In any method, the single crystal layer is formed with a desired film thickness.

Next, as shown in FIG. 2B, an SiO₂ layer constituting a protective layer 103 is formed on the surface of the porous silicon 102 which is the same surface as that of the silicon substrate 101. At this time, if the protective layer 103 is formed on at least the surface of the porous silicon 102, the protective layer may be formed on the surface of the silicon substrate 101. The porous silicon 102 is removed later, and this removed portion forms a flow path. Therefore, the porous silicon 102 needs to be isolated by the protective layer 103 so as to prevent the porous silicon 102 from being brought into contact with a heating portion to be formed in the subsequent step. Examples of a specific method of forming the protective layer 103 include a P-CVD method. The protective layer may be formed by a sputtering method. As the protective layer 103, SiN may be used.

Next, as shown in FIG. 2C, a heating member is laminated. Examples of a material forming the heating member include TaN and TaSiN. In addition, an element such as tungsten or titanium may selected and used according to a necessary resistance value. This heating member is subjected to patterning by a photolithographic technology to form a heating portion 104. It is to be noted that the above method of forming the heating portion 104 is merely one example, and the present invention is not limited to this method.

Next, as shown in FIG. 2D, a wiring line layer is formed, and subjected to the patterning by the photolithographic technology so as to form a wiring line 105 of the above heating portion. As a material forming the wiring line layer, a material such as Al having an excellent conductivity can be used, but the present invention is not limited to this example.

According to a method of manufacturing the ink jet recording head of the present invention, as shown in FIG. 2E, a layer forming a heat storage layer 106 can be formed on a substrate provided with the heating portion 104 and the wiring line 105. The heat storage layer is disposed for a purpose of efficiently transmitting heat generated by the heating portion. That is, when the material layer having an excessively high heat conductivity is brought into contact with the heating portion, the generated heat is transmitted to the material layer in preference to a liquid. Therefore, since the heat generated by the heating portion needs to be held at an interval of a discharge pulse signal level, the heat storage layer performs a function of holding the heat. It is to be noted that examples of a material forming the heat storage layer 106 include SiO₂, but the present invention is not limited to this example, and the material can appropriately be selected according to a desired conductivity and material properties. In the ink jet recording head of the present invention, the heat storage layer can bear a part of a member constituting a discharge port 107.

Next, as shown in FIG. 2F, the discharge port 107 is formed by a method such as etching. In this case, the porous silicon may be exposed in order to perform a step of removing the porous silicon as described later. If the protective layer 103 is present in a position forming a flow path leading to this discharge port 107, the layer is also removed. When the heat storage layer 106 formed of an SiO₂ layer and the member constituting the heat storage layer is present in a position where the discharge port is to be formed, the member is also removed. In the ink jet recording head of the present invention, a material layer constituting an orifice (discharge port) plate may be formed on a layer above the heating portion 104 and the wiring line 105 according to a dimension and a shape of the discharge port. Specifically, after the material layer is formed, the discharge port is formed so as to pass through the porous silicon from the material layer. The material layer constitutes the orifice (discharge port) plate. When the heat storage layer is disposed as described above, the orifice plate may be formed on a layer above the heat storage layer. Alternatively, the orifice plate may be constituted as the heat storage layer.

Next, as shown in FIG. 2G, an ink supply opening 108 is formed by etching.

Finally, as shown in FIG. 2H, the porous silicon 102 is removed to complete the ink jet recording head. As a specific method in this case, the material is immersed into one of an aqueous potassium hydroxide solution or a tetramethyl ammonium hydroxide (TMAH) solution, and the porous silicon is eluted from the previously formed supply opening to remove the silicon. In this case, the non-porous single crystal layer of silicon performs a function of filling in the pores to smoothen the surface, but this layer is also removed. If the non-porous single crystal layer remains, an etching gas such as CF₄ can be introduced into this remaining portion to remove the layer.

An example will be described below to describe the present invention in more detail.

### EXAMPLE 1

First, opposite surfaces of a silicon substrate 101 having a thickness of 300 μm were coated with 1 μm of a polyimide resin, an opening was made by photolithography so as to expose a position where porous silicon was to be formed, and a mask was formed. Subsequently, anode formation was performed in an HF solution. Anode formation conditions were as follows:

current density: 30 (mA·cm⁻²);

anode forming solution: HF:H₂O:C₂H₅OH=1:1:1;

time: 12 minutes;

thickness of porous silicon: 20 μm; and

porosity of silicon: 56%.

In consequence, porous silicon 102 was formed at a region having a shape of a 60μ wide square and a thickness of 20 μm in the exposed portion. Next, a mask material made of the polyimide resin was removed, and SiH₄ was added to a hydrogen carrier gas so as to set a concentration to 28 ppm at 950° C. in an electric furnace. Subsequently, a treatment was performed for 200 seconds, and the addition of SiH₄ was completed. Subsequently, the temperature was lowered to 900° C., and SiH₂Cl₂ was added so as to set a concentration to 0.5 mol %. According to this step, porous single crystal silicon was formed, and the surface of the porous silicon 102 as an upper portion of the silicon substrate was sealed and smoothened (FIG. 2A).

Subsequently, an SiO₂ layer was formed with a thickness of 0.1 μm on the surface of the substrate by use of a P-CVD process to form a protective layer 103 (FIG. 2B)

Next, a TaN film having a thickness of 0.05 μm was formed as a heating resistance layer, and subjected to patterning by the photolithography so as to obtain a thickness of 15 μm, thereby forming a heating portion 104 (FIG. 2C).

Next, a wiring line layer made of Al was formed with a thickness of 1 μm, and subjected to the patterning by use of the photolithography to form wiring lines 105 (FIG. 2D).

Next, to form a heat storage layer provided with a discharge port on the wiring line layer, an SiO₂ layer having a thickness of 15 μm was formed by use of the P-CVD process to form a heat storage layer 106 (FIG. 2E).

Next, to form the discharge port, an etching mask was prepared using the photolithography, and a columnar discharge port 107 having a bore diameter of 10 μm was formed in the heat storage layer by dry etching (FIG. 2F).

Next, to form an ink supply opening, an etching mask was formed on the back surface of the substrate by use of the photolithography, and an ink supply opening 108 having a bore diameter of 20 μm was formed in the silicon substrate by the dry etching (FIG. 2G).

Finally, the material was immersed into a KOH solution to remove the porous silicon so that the ink supply opening 108 communicated with the discharge port 107 (FIG. 2H). In consequence, a flow path 109 was formed.

As described above, an ink jet recording head was completed.

The completed head was electrically connected, bonded to a member to which ink was to be supplied, and mounted on a recording apparatus. When printing was performed, a satisfactory recorded image was obtained. As a result of detailed observation, a droplet had a size in such a necessary range as to satisfy an image quality level, and disturbances of shot intervals due to instability of bubbling were not seen.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2006-110941, filed Apr. 13, 2006 which is hereby incorporated by reference herein in its entirety.

What is claimed is:

1. A manufacturing method of a liquid discharge head having a discharge port which discharges a liquid, a flow path which communicates with the discharge port, a heating portion which is disposed correspondingly to the flow path and which generates heat energy for use in discharging the liquid from the discharge port and a protective layer which prevents the heating portion from being brought into contact with the liquid, the method comprising:
forming porous silicon from a surface to an inner portion of a silicon substrate;
sealing pores present in the surface of the porous silicon to smoothen the surface of the porous silicon;
forming the protective layer on the smoothened surface of the porous silicon;
forming the heating portion on the protective layer;
forming the discharge port; and
removing the porous silicon to form the flow path.

2. The manufacturing method of the liquid discharge head according to claim 1, wherein the forming of the discharge port includes exposing the porous silicon.

3. The manufacturing method of the liquid discharge head according to claim 1, further comprising, after forming the heating portion:
forming a heat storage layer on the heating portion.

4. The manufacturing method of the liquid discharge head according to claim 1, wherein the smoothening of the surface of the porous silicon includes forming a non-porous single crystal thin layer on the surface of the porous silicon.

5. The manufacturing method of the liquid discharge head according to claim 1, wherein the pores of the porous silicon are sealed to set a density of the pores remaining in the surface of the porous silicon to 1×10⁸ cm⁻² or less.

6. The manufacturing method of the liquid discharge head according to claim 1, wherein the protective layer is made of SiO₂.

7. The manufacturing method of the liquid discharge head according to claim 3, wherein the heat storage layer is made of SiO₂.
